(19) United States
(12) Patent Application Publication
(10) Pub. No.: US 2006/0235852 A1
(43) Pub. Date: Oct. 19, 2006

(54) System for inter-database communication

(75) Inventor: Mark Gaug, Vestal, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Lockheed Martin Corporation

(21) Appl. No.: 11/105,693

(22) Filed: Apr. 14, 2005

(51) Int. Cl. G06F 17/30

(52) U.S. Cl. 707/10

(57) ABSTRACT

A system aggregates communication data. The system includes a client and a data access gateway. The data access gateway receives a single request from the client. The data access gateway composes a first query and a second query. The first query and the second query together satisfy the single request from the client. The data access gateway simultaneously routes the first query and the second query to a first database and a second database, respectively. The first database receives the first query from the data access gateway. The first database formulates a first response corresponding to the first query from the data access gateway. The first database provides the first response to the data access gateway. The second database receives the second query from the data access gateway. The second database formulates a second response corresponding to the second query from the data access gateway. The second database provides the second response to the data access gateway. The data access gateway aggregates the first response and the second response to produce a single aggregated response for the client. The aggregated response comprises data from both the first and second responses. The data satisfies the single request from the client.

### FEDERAL SPONSORSHIP

The U.S. Government has a paid-up license in this invention and the right, in limited circumstances, to require the patent owner to license others on reasonable terms as provided for by the terms of Contract No. 512593-01-B-1730 awarded by the United States Postal System.

### FIELD OF INVENTION

The present invention relates to a system for database communication, and more specifically, to a system for aggregating multiple queries into a single query.

### BACKGROUND OF THE INVENTION

Many organizations comprise data islands. These organizations have utilized conventional systems for attempting to relate these islands together by connecting to multiple databases directly and to obtain a result in a synchronous manner. Alternatively, another conventional system queries multiple data sources manually (i.e., mostly by looking at output reports from mail processing machines, etc.) and by manual analysis.

For example, the United States Postal System (USPS) may have many different data sources in many different facilities all attached by a Postal Wide Area Network. Currently, the USPS processes and handles mail at three hundred Processing and Distribution Centers and 25 Bulk Mail Centers. Each center may have up to one hundred twenty different pieces of main processing/handling equipment. Each piece of equipment may have data containing mail piece, status, states, and run information.

Business, maintenance, and operations personnel may require aggregated data to make informed decisions. Conventionally, USPS data is gathered: anecdotally (an operator observing that she/he only had two jams on a given day), through facility wide numbers (forty million pieces have been processed in a given month), through individual paper reports aggregated manually (usually through a spreadsheet), and/or through individual machine databases or Integrated Data System (IDS) databases using custom queries and programmatically aggregating the data.

### SUMMARY OF THE INVENTION

A system in accordance with the present invention aggregates communication data. The system includes a client and a data access gateway. The data access gateway receives a single request from the client. The data access gateway composes a first query and a second query. The first query and the second query together satisfy the single request from the client. The data access gateway simultaneously routes the first query and the second query to a first database and a second database, respectively. The first database receives the first query from the data access gateway. The first database formulates a first response corresponding to the first query from the data access gateway. The first database provides the first response to the data access gateway. The second database receives the second query from the data access gateway. The second database formulates a second response corresponding to the second query from the data access gateway. The second database provides the second response to the data access gateway. The data access gateway aggregates the first response and the second response to produce a single aggregated response for the client. The aggregated response comprises data from both the first and second responses. The data satisfies the single request from the client.

A data access gateway in accordance with the present invention aggregates communication data. The data access gateway includes a first data tier, a second data tier, and a business logic tier. The business logic tier receives a single request from a client. The business logic tier composes a plurality of requests. The plurality of requests satisfies the single request from the client. The plurality of requests comprises a first request and a second request. The business logic tier simultaneously routes the first request to the first data tier and the second request to the second data tier. The first data tier receives the first request from the business logic tier. The first data tier formulates a first query corresponding to the first request from the business logic tier. The first data tier routes the first query to a first database. The first data tier receives a first response from the first database and asynchronously routes the first response to the business logic tier. The second data tier receives the second request from the business logic tier. The second data tier formulates a second query corresponding to the second request from the business logic tier. The second data tier routes the second query to a second database. The second data tier receives a second response from the second database and asynchronously routes the second response to the business logic tier. The data access gateway aggregates the first response and the second response to produce a single aggregated response for the client. The aggregated response comprises data from both the first and second databases. The aggregated response satisfies the single request from the client.

A computer program in accordance with the present invention aggregates communication data. The computer program product includes: a first instruction for receiving requests by a business logic tier from a client; a second instruction for transforming the requests into a plurality of requests; a third instruction for transferring each request from the business logic tier to an appropriate data tier; a fourth instruction for receiving a request from the business logic tier by the appropriate data tier; a fifth instruction for routing requests from a data tier to an appropriate database and receiving responses from an appropriate database by the data tier; a sixth instruction for asynchronously routing a data response from the appropriate database to the business logic tier; a seventh instruction for receiving results by the business logic tier; an eighth instruction aggregating the results from appropriate data tiers into a single aggregated response; and a ninth instruction for routing the single aggregated response to the client.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of an example system in accordance with the present invention;

FIGS. 2A-2E are a schematic representation of another example system in accordance with the present invention;

FIG. 3 is a schematic representation of still another example system in accordance with the present invention;

FIG. 4 is a schematic representation of yet another example system in accordance with the present invention; and

FIG. 5 is a schematic representation of an example computer program in accordance with the present invention.

### DESCRIPTION OF AN EXAMPLE EMBODIMENT

A system in accordance with the present invention utilizes a modular approach (via the use of configuration files, stylesheets, plug-in Dynamic Link Libraries, etc.) to aggregate data from multiple data sources into a simple web service interface. There are typically numerous sources of data. The system attaches to each source asynchronously, queries necessary information, aggregates the resultant data through a combination of stylesheets and/or custom code in a Dynamic Link Library, and provides a result to a client user. Asynchronous communication allows the resultant system to simultaneously communicate with hundreds of data sources.

As stated above, many organizations comprise data islands. These organizations have utilized conventional systems for attempting to relate these islands together by connecting to multiple databases directly and to obtain a result in a synchronous manner. Alternatively, another conventional system queries multiple data sources manually (i.e., mostly by looking at output reports from mail processing machines, etc.) and by manual analysis.

The system provides an easily updatable, extensible, and automatic interface to aggregate data to advantageously build web service clients. The system provides a web service software interface for data that allows the querying and aggregation of multiple data sources as a single response to the requesting client (scalable to hundreds of data sources). The system further embeds defined interface protocols into the underlying data that prevent excessive loading of a data source from ad hoc queries. Thus, the system allows easy update and maintenance of the defined interfaces without requiring recompilation of the Web service itself through the use of configuration files, stylesheets, and the Dynamic Link Libraries.

The system may provide a facility to query data in real time from multiple data sources at multiple facilities and to provide the result into a single response. The system defines a web service with defined queries. The system allows modifications and additions of queries without requiring the recompilation of the web service itself. Thus, real time data may eliminate guesswork of labor intensive data gathering for many management decisions. Further, real time data from multiple sites may allow future enterprise information systems and executive dashboards.

The system may structure access to databases while preventing ad hoc queries from monopolizing a processor. The system may allow adding additional queries without the need of another software release. Web service may pass through queries from one connected network to another network thereby allowing data gathering and aggregation directly from MPE located on a separate network. The system may provide a data gateway for any enterprise management/reporting system that may communicate with web services.

The system may provide a web service middle tier that may, for example, be utilized by the United States Postal Service (USPS). The system may further provide an interface including an Integrated Data System (IDS) and/or a Data Access Gateway (DAG). The DAG is a software element that runs as a web service application.

The DAG may provide defined interfaces into underlying data for preventing excessive loading of a data source from ad hoc queries. The DAG may allow easy update and maintenance of defined interfaces without requiring recompiling of the Web service itself through the use of configuration files, stylesheets, and a Dynamic Link Libraries (DLL). The DAG allows querying and aggregation of multiple USPS data sources, for example, as a single response to a requesting client (scalable to hundreds of data sources) through the use of true synchronous communication between DAG Web Service middleware and a data tier. This may be accomplished by issuing web service requests to the data tier web interface and receiving the web service responses from the DAG web interface.

As stated above, the system may allow easy update and maintenance of defined interfaces without requiring the recompiling of Web service through the use of XSLT stylesheets and custom DLLs allowing aggregation and data transformation of data from many different data tiers. The system further permits updating the client interface without requiring a recompile through the use of files (configuration files and Web Service Design Language (WSDL)).

The DAG interface may anticipate a format of messages that a user may request. The data in the database, for instance, may have a complex format thereby creating complex queries. The DAG interface may isolate a user from these queries.

The Web Service interface may be a standard interface. Interfaces processing elementary data types (integers, strings, etc) and XML strings may be easily useable with client data written in either JAVA or .NET platforms.

However, there are certain programming productivity advantages in the .NET framework (i.e., returning datasets directly, etc.). All DAG data interfaces may accept an XML string as input and yield an output XML string that may be easily translated into a Dataset (i.e., a Microsoft Peculiar Data Format, etc.).

The DAG interface may be a three tier system. The User Interface may be the client system. The business tier may be the DAG client interface. The DAG client interface may consist of actual interfaces and may have the capability to verify security, validate input messages, compose and route requests to a data tier, and format and aggregate results to a client system. A Data Tier may provide an interface into actual data sources of the DCS. The Data Tier may allow input queries of the data and may allow data to be returned to the interface or written to a file. The interface may also allow canceling existing queries.

A service facade may be an access point to any user of the gateway. The service facade may have a defined message input for each type of data request (referred to an interface). Each input interface may have a WSDL that contains the actual XSD schema for input. This may allow users to validate the input to the same extent as the server does.

One function of the Business Logic Tier may be authentication. The Business Logic Tier may use 0.509 certificates for authentication. WS Security and WS Trust standards may be chosen for authentication via 0.509 certificates. The data tier may also use this authentication. The Business Logic Tier may use SOAP extensions to validate the incoming XML message to the Schema contained in the Web Service Design Language (WDSL) for the client interface.

The Business Logic Tier may translate an incoming SOAP request into a Query String and provide the Query String to the Data Tier. All incoming messages may be XML messages within SOAP. An XSLT style sheet may translate XML to another formatted output. The service facade may take the incoming SOAP message and, after validating the schema, forward the incoming XML through an XSLT translator. The Web method called from the client may not even be written. This means that there may be identical processing that occurs in any input interface. A configuration file may control the XSLT Style sheet.

The Business Logic Tier may share common routines with the Data Tier. One class of these may be exception, logging, and tracing routines. There may be common routines responsible for exception handling and for logging and timestamping messages as the messages move through the interface.

Exception logging, tracing, and logging may also be executed through common logging routines. These routines may provide a common interface for routines.

The Business Logic Tier may generate a query string and route the query string to the proper data tier element(s). The Business Logic Tier may route messages to many data tier elements. Each data tier type may have an Output Service Agent that initiates and controls the communication to the data tier. The Output Service Agent may communicate to the Data tier with a web service request. The Data Tier may respond immediately that it received the message. Later, upon completion of the request and when return data is available, the web service may respond to the DAG web service with its response. This may allow asynchronous communication between the Business Logic Tier and the Data Tier. The typical single web service request to the Data Tier may be rejected since the request may not be scalable to hundreds of simultaneous requests.

Upon receiving responses, the Business Logic Tier may then aggregate and translate the data from the many data tier responses by the use of a XSLT style sheet and an Aggregation Service Agent. The Aggregation Service Agent may be a custom DLL that allows for additional transformation not accomplished by the XSLT style sheet. Use of Dynamic Linked Libraries (DLL) may allows multipass queries, where the output to one query may be used as the input to another. DLLs also may allow the interface to be modified without recompiling the entire application. The Aggregator also may track requests and responses to/from the data tier to automatically respond when responses time out and to provide status inquires or cancel commands for any existing queries.

The Business Logic Tier may also monitor messages as the messages progress through the system. As a part of the interface, input messages may have a unique ID. The unique ID may allow the locating at any time. When the interface requests the status or the cancellation of a current message, the Business Logic Tier may route the message. The Business Logic Tier may automatically respond when data tier elements do not respond within a preset time.

The Business Logic Tier may have an output service agent, implemented as a custom Dynamic Linked Library for each type of data tier element. This may include a Zip interface, a PIMS interface, and a Database interface. These interfaces may communicate with the web services of the data tier. New interfaces may be added with changes to a configuration file and possibility the addition of a new Output Service Agent (without a recompile of the entire application).

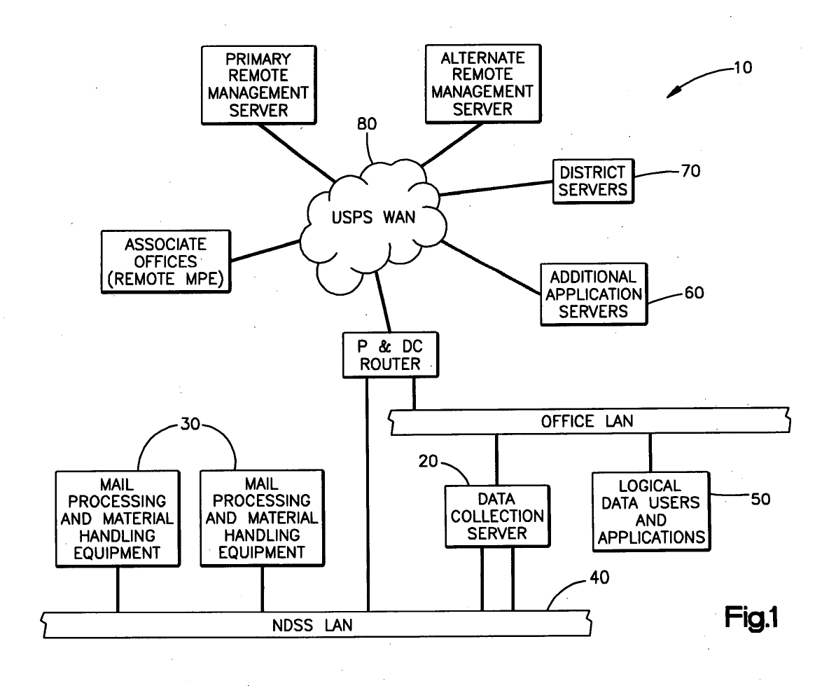

FIG. 1 shows an example system 10 in which a DAG interface in accordance with the present invention may function. The DAG interface may function as part of a Data Collection Server 20. The DAG interface may collect data from Mail Processing and Material Handling Machines 30 over a NDSS LAN 40. Users of the data may be Logical Data Users and Applications 50, additional Application Servers 60, and District Servers 70. These may be located on a Postal WAN 80. The NDSS LAN 40 may not have direct data connectivity with the Postal WAN 80 (FIG. 1).

The DAG interface, a middle tier application, may be a part of the Data Collection Server 20 and may collect/access data from the Mail Processing and Material Handling Equipment 30 and return the data, in a useable form, to users of the Postal WAN 80. Being a middle tier application may allow a user to access data remotely across various network WANs.

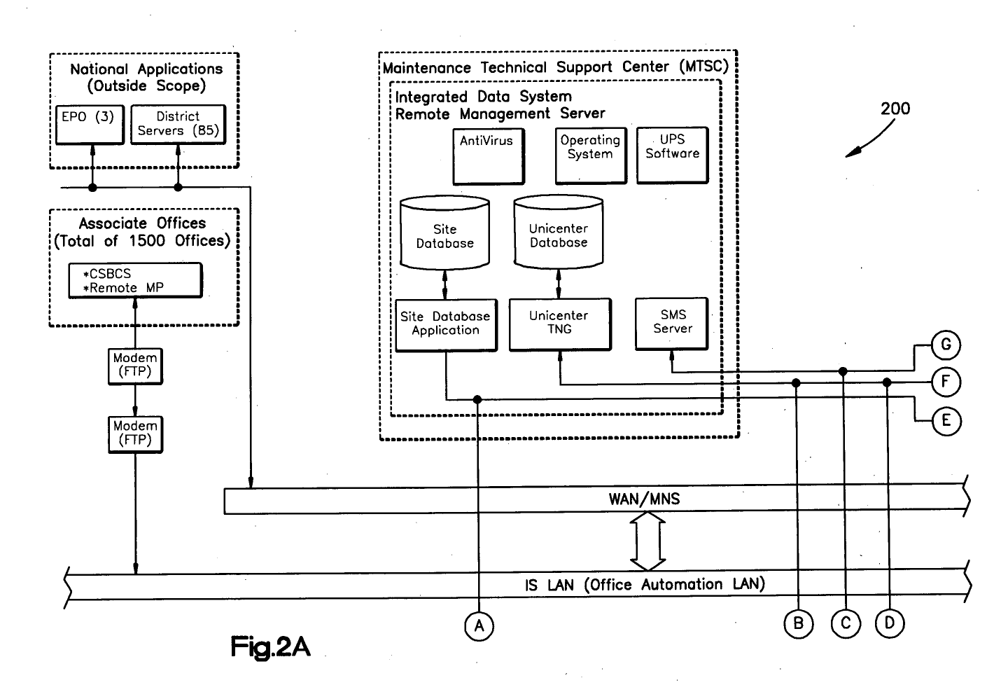

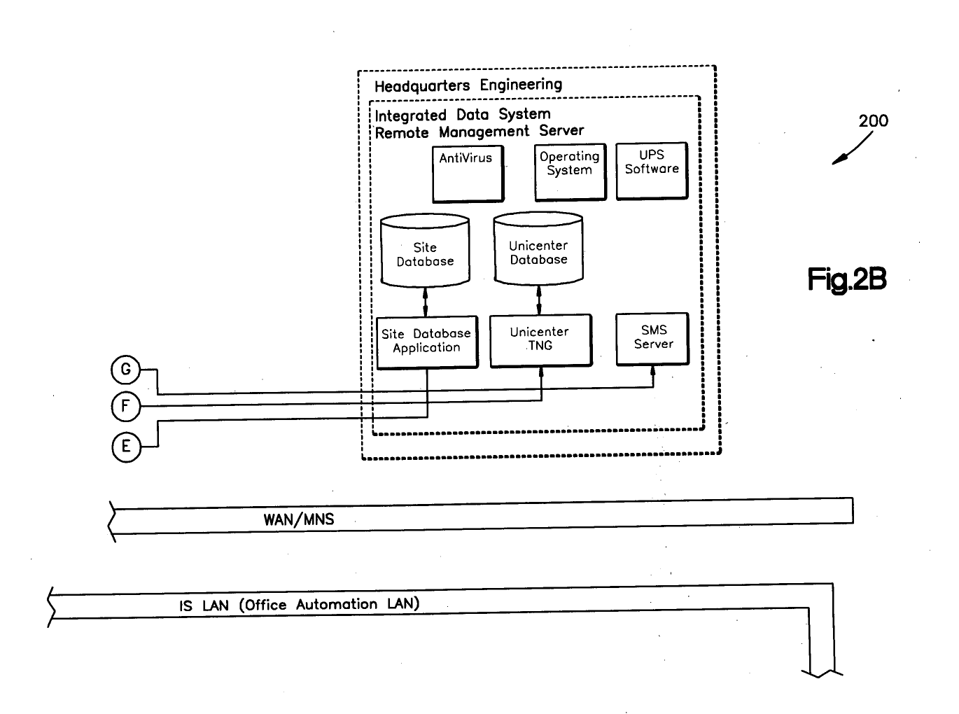

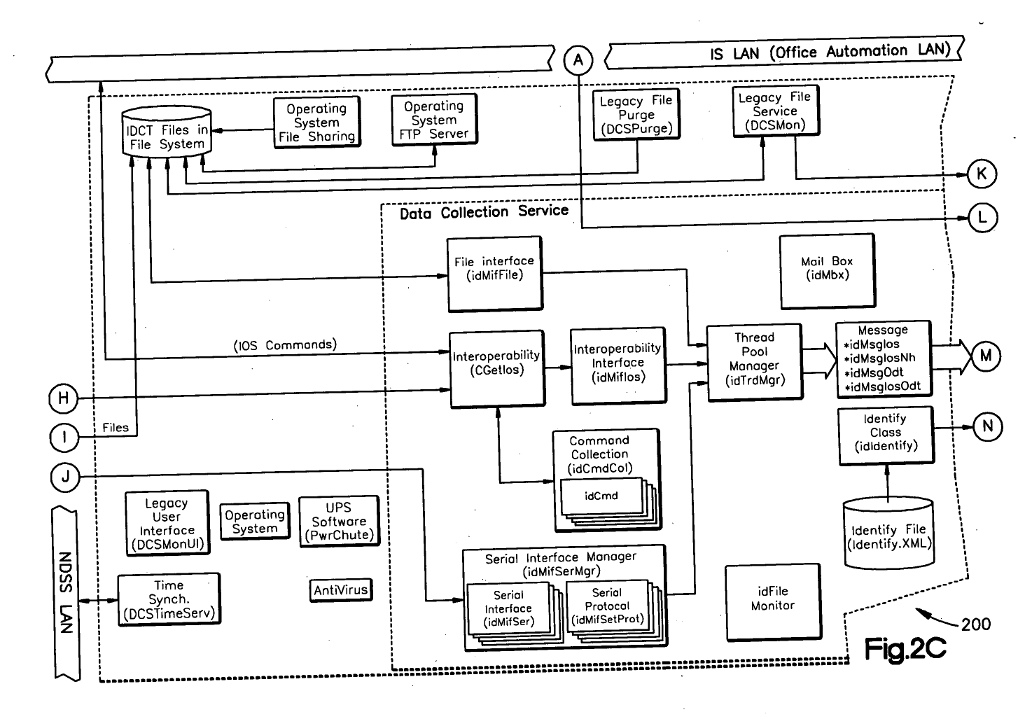

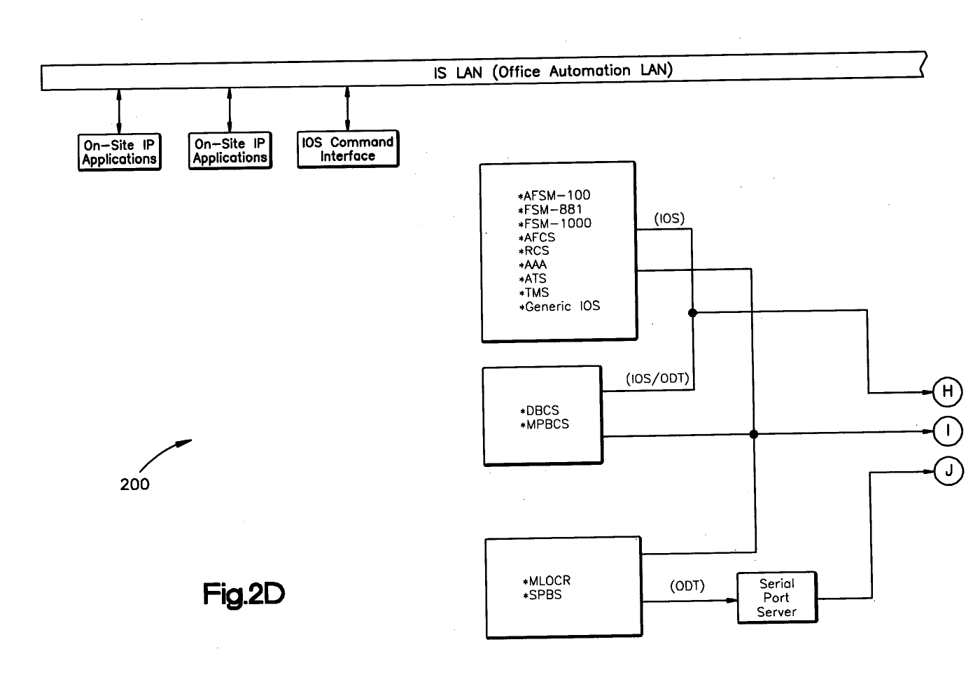

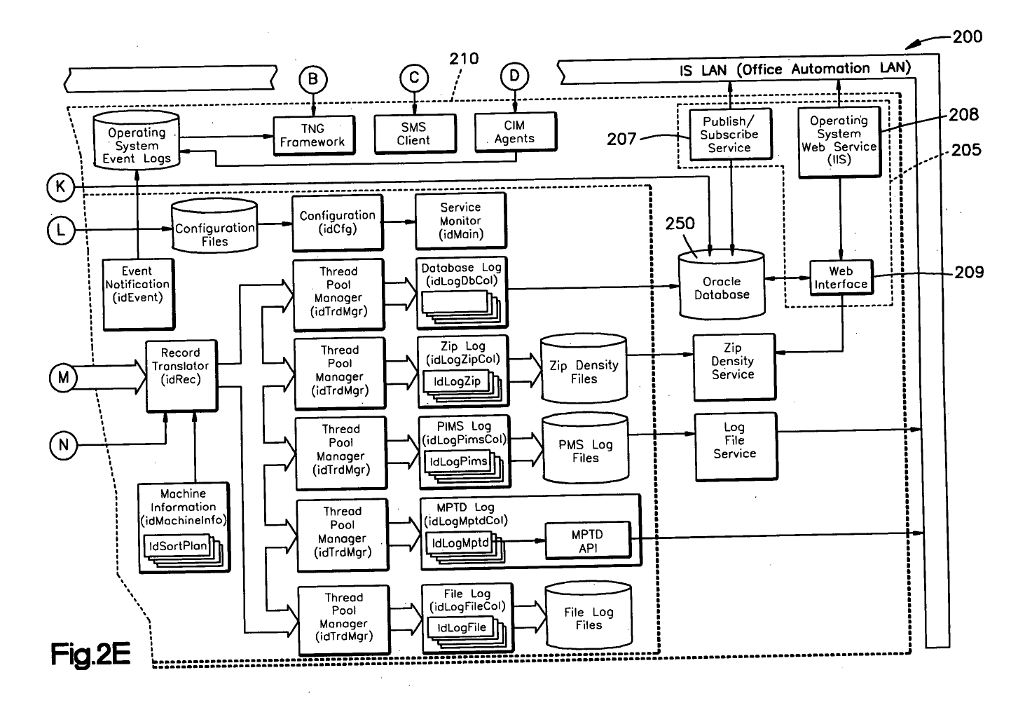

FIG. 2 an example system 200 that may include a Data Collection Server (DCS) 210. The DCS 210 may include an Operating System 215, a Legacy User interface 220, Antivirus Time synchronization 230, Data Collection Service 240, an Oracle Database 250, and legacy file services 260. Additional functionality (i.e., the DAG interface) may not be permitted to interfere with the current functionality of the Data Collection Server 210.

The DAG interface (FIG. 2E) may provide a managed interface into the data stores of the DCS 210. The DAG interface 205 may include the functionality of a Publish/Subscribe Service 207, an Operating System Web Service 208, and a Web Interface 209. Unrestricted access to a database may allow queries for datasets that have millions of rows thereby causing interruptions in ongoing data collection functions. The DAG interface 205 may allow only predefined queries that will prevent this from happening.

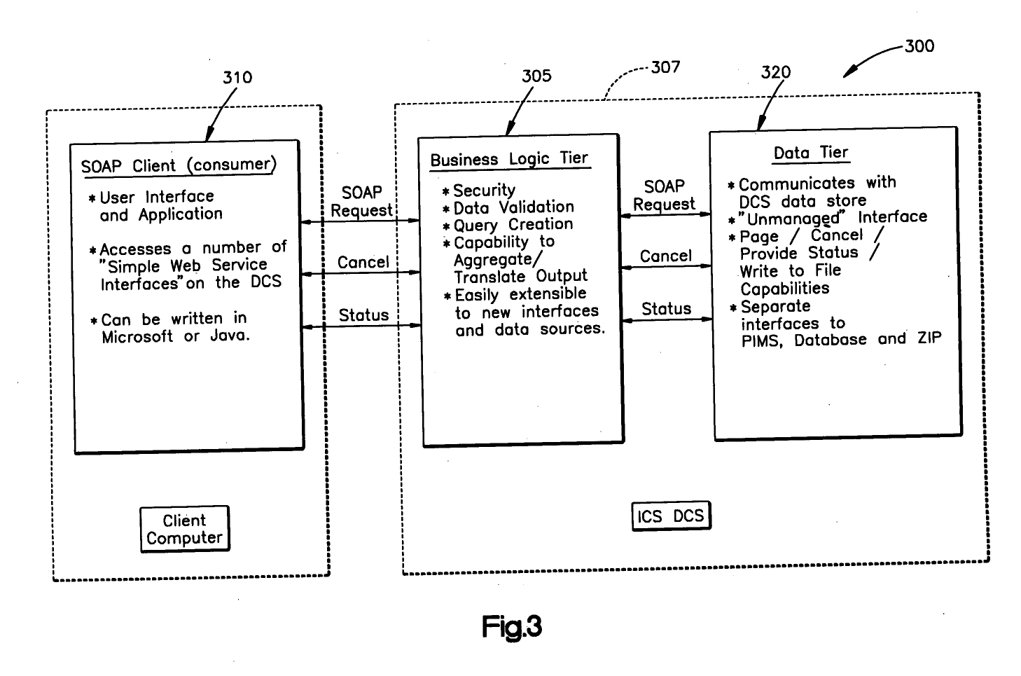

FIG. 3 shows an example high level design diagram 300 for a DAG interface 307 in accordance with the present invention. A client application 310 may provide a SOAP (Simple Object Access Protocol) message to the DAG interface 307. The DAG interface 307 may include a Business Logic Tier 305 and a Data Tier 320. The Business Logic Tier 320 may authenticate the user and validate the input parameters.

The Business Logic Tier 305 may translate input and route a result to an individual Data Tier 320 by asynchronous communication. The Data Tier 320 may retrieve data. The Business Logic Tier 305 may aggregate a response as a single response back to the SOAP client 310.

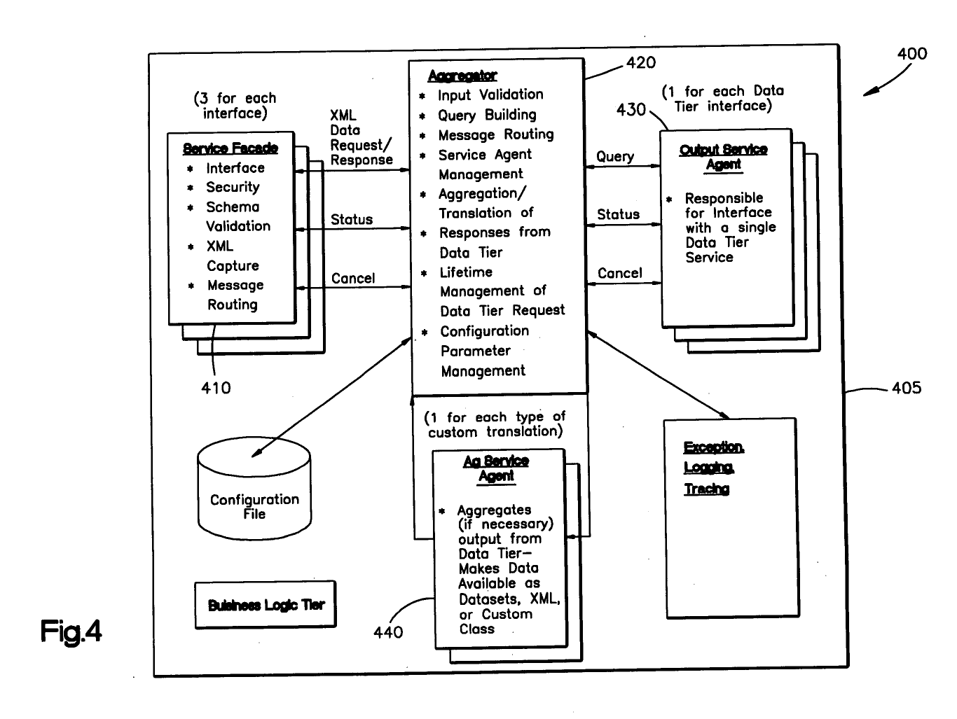

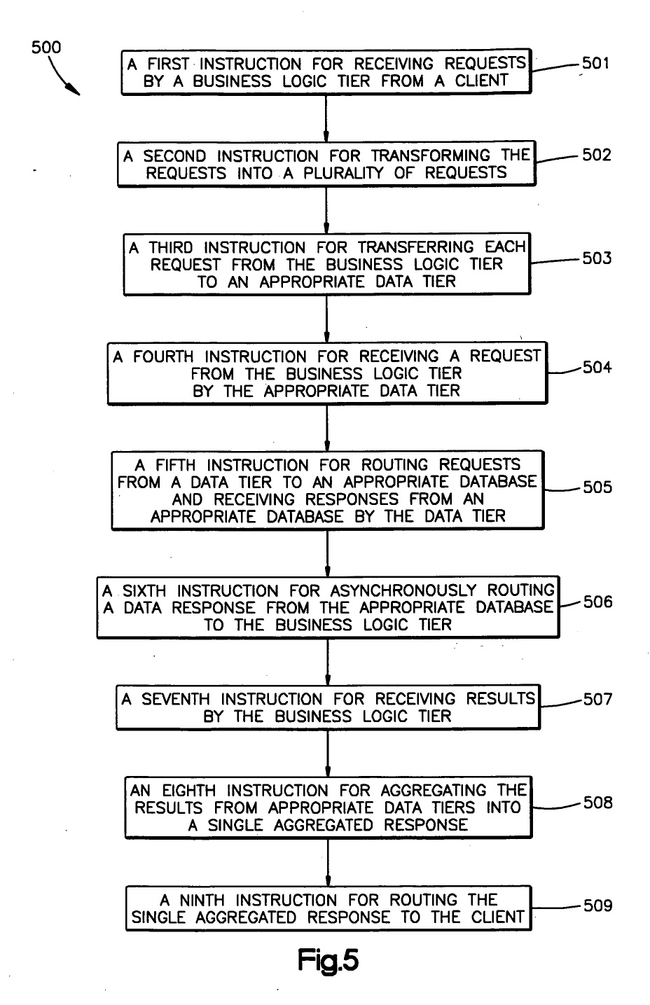

FIG. 4 shows an example system 400 for use with a Business Logic Tier that is part of a DAG interface 405 in accordance with the present invention. The system 400 may include a Service Facade 410, an Aggregator 420, an Output Service Agent 430 to communicate with data tier elements (not shown), and an Ag Service Agent 440.

The Service Facade 410 may be responsible for authentication, validation, and actual client interfacing. Additional interfaces may be added without recompiling the interface 405. The Aggregator 420 may be responsible for transposing input using Stylesheets and/or custom DLLs to an Output Service Agent 430 (composed of DLLs). The Output Service Agent 430 may route resultant messages asynchronously to a Data Tier (not shown) of the system 400. The Data Tier may route a result back to the Business Logic Tier 405 over a Web service interface. The Aggregator 420 may translate and aggregate a result into a single response with an Ag Service Agent 440 composed of a custom DLL and/or a Style sheet. This single response may then be routed back to a client (not shown).

An example computer program in accordance with the present invention aggregates communication data. The computer program product includes: a first instruction 501 for receiving requests by a business logic tier from a client; a second instruction 502 for transforming the requests into a plurality of requests; a third instruction 503 for transferring each request from the business logic tier to an appropriate data tier; a fourth instruction 504 for receiving a request from the business logic tier by the appropriate data tier; a fifth instruction 505 for routing requests from a data tier to an appropriate database and receiving responses from an appropriate database by the data tier; a sixth instruction 506 for asynchronously routing a data response from the appropriate database to the business logic tier; a seventh instruction 507 for receiving results by the business logic tier; an eighth instruction 508 aggregating the results from appropriate data tiers into a single aggregated response; and a ninth instruction 509 for routing the single aggregated response to the client.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for aggregating communication data, said system comprising:
a client; and
a data access gateway for receiving a single request from said client, said data access gateway composing a first query and a second query, said first query and said second query together satisfying the single request from said client, said data access gateway simultaneously routing said first query and said second query to a first database and a second database, respectively,
said first database receiving said first query from said data access gateway, said first database formulating a first response corresponding to said first query from said data access gateway, said first database providing said first response to said data access gateway,
said second database receiving said second query from said data access gateway, said second database formulating a second response corresponding to said second query from said data access gateway, said second database providing said second response to said data access gateway,
said data access gateway aggregating said first response and said second response to produce a single aggregated response for said client, said aggregated response comprising data from both said first and second responses, said data satisfying said single request from said client.

2. The system as set forth in claim 1 wherein said data access gateway includes a business logic tier for validating the plurality of requests.

3. The system as set forth in claim 1 wherein said data access gateway includes a business logic tier for creating the first query and the second query.

4. The system as set forth in claim 1 wherein said data access gateway includes a business logic tier for validating the first response from the first database and the second response from the second database.

5. The system as set forth in claim 1 wherein said data access gateway includes a business logic tier for aggregating the first response and the second response.

6. The system as set forth in claim 1 wherein said data access gateway includes a data tier for asynchronously communicating with the first database and the second database.

7. The system as set forth in claim 1 wherein said data access gateway includes a data tier for translating the first response and the second response into a common format.

8. The system as set forth in claim 1 wherein said first database and said second database independent and part of a common database, said first and second databases residing on multiple systems.

9. The system as set forth in claim 1 wherein said data access gateway communicates with said first database asynchronously.

10. The system as set forth in claim 9 wherein said data access gateway communicates with said second database asynchronously, said data access gateway simultaneously contacting and retrieving data from multiple data stores.

11. A data access gateway for aggregating communication data, said data access gateway comprising:
a first data tier;
a second data tier; and
a business logic tier for receiving a single request from a client, said business logic tier composing a plurality of requests, said plurality of requests satisfying the single request from the client,
said plurality of requests comprising a first request and a second request, said business logic tier simultaneously routing said first request to said first data tier and said second request to said second data tier,
said first data tier receiving said first request from said business logic tier, said first data tier formulating a first query corresponding to said first request from said business logic tier, said first data tier routing said first query to a first database, said first data tier receiving a first response from the first database and asynchronously routing the first response to said business logic tier,
said second data tier receiving said second request from said business logic tier, said second data tier formulating a second query corresponding to said second request from said business logic tier, said second data tier routing said second query to a second database, said second data tier receiving a second response from the second database and asynchronously routing the second response to said business logic tier,
said data access gateway aggregating the first response and the second response to produce a single aggregated response for the client, said aggregated response comprising data from both the first and second databases, said aggregated response satisfying the single request from the client.

12. The data access gateway as set forth in claim 11 wherein said business logic tier includes an output service agent for communicating with said data tier.

13. The data access gateway as set forth in claim 11 wherein said business logic tier includes a service facade for communicating with the client and an aggregator service agent for communicating with said service facade.

14. The data access gateway as set forth in claim 12 wherein said business logic tier includes an aggregator for translating responses from said data tier into a common format.

15. The data access gateway as set forth in claim 11 wherein said business logic tier includes a configuration file.

16. A computer program product for aggregating communication data, said computer program product comprising:
a first instruction for receiving requests by a business logic tier from a client;
a second instruction for transforming the requests into a plurality of requests;
a third instruction for transferring each request from the business logic tier to an appropriate data tier;
a fourth instruction for receiving a request from the business logic tier by the appropriate data tier;
a fifth instruction for routing requests from a data tier to an appropriate database and receiving responses from an appropriate database by the data tier;
a sixth instruction for asynchronously routing a data response from the appropriate database to the business logic tier;
a seventh instruction for receiving results by the business logic tier;
an eighth instruction for aggregating the results from appropriate data tiers into a single aggregated response; and
a ninth instruction for routing the single aggregated response to the client.

17. The computer program product as set forth in claim 16 further including a tenth instruction for updating a plurality of interfaces without recompiling said plurality of interfaces.

18. The computer program product as set forth in claim 16 further including a tenth instruction for anticipating a format of the first request.

19. The computer program product as set forth in claim 16 further including a tenth instruction for validating data from the data tier.

20. The computer program product as set forth in claim 16 further including a tenth instruction for determining a common format of the single aggregate response.
